(19) United States
(12) Patent Application Publication
(10) Pub. No.: US 2024/0184580 A1
(43) Pub. Date: Jun. 6, 2024

(54) Tracking of Data Readiness for Load and Store Operations

(71) Applicant: SiFive, Inc., San Mateo, CA (US)

(72) Inventor: Yueh Chi Wu, Taichung City (TW)

(21) Appl. No.: 18/328,839

(22) Filed: Jun. 5, 2023

Related U.S. Application Data
(60) Provisional application No. 63/429,927, filed on Dec. 2, 2022.

(51) Int. Cl. G06F 9/30; G06F 9/38

(52) U.S. Cl. CPC G06F 9/30043; G06F 9/3836

(57) ABSTRACT

A method for tracking of data readiness for load and store operations is disclosed. The method includes establishing a Load Transfer Buffer (LTB) entry, initializing a write counter configured to track a number or progress of write data that are expected to update the LTB entry, and tracking the number or progress of the write data that are expected to update the LTB entry. The tracking can include setting, in the write counter, the number of the write data that are expected to update the LTB entry, maintaining, until a next respective write data arrives to the LTB entry a current value corresponding to a respective number of write data left to update the LTB entry, and after receiving the next respective write data, adjusting the write counter to reflect a respective number of write data left to update the LTB entry.

### CROSS REFERENCE TO RELATED APPLICATION

This application claims priority to and the benefit of U.S. Patent Application Ser. No. 63/429,927, filed on Dec. 2, 2022, the entire disclosure of which is hereby incorporated by reference.

### TECHNICAL FIELD

This disclosure relates generally to integrated circuits and, more specifically, data readiness in out-of-order processors.

### BACKGROUND

A central processing unit (CPU) or processor core may be implemented according to a particular microarchitecture. As used herein, a “microarchitecture” refers to the way an instruction set architecture (ISA) (e.g., the RISC-V instruction set) is implemented by a processor core. A microarchitecture may be implemented by various components, such as decode units, rename units, dispatch units, execution units, registers, caches, queues, data paths, and/or other logic associated with instruction flow. A processor core may execute instructions in a pipeline based on the microarchitecture that is implemented.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a system for facilitating generation and manufacture of integrated circuits.

FIG. 2 is a block diagram of an example of a system for facilitating generation of a circuit representation.

FIG. 3 is a block diagram of an example of an integrated circuit including a primary pipeline, a vector pipeline, and a counter.

FIG. 4 is a block diagram illustrating a relationship between a Load Store unit (LSU), a Baler, and a Vector Unit or Processor (VU).

FIG. 5 is a block diagram illustrating flow between elements in the LSU and the Baler unit for Load Transfer Buffer (LTB) data readiness tracking.

FIG. 6 is a block diagram illustrating flow between elements in the LSU and the Baler unit for Store Transfer Buffer (STB) data readiness tracking.

FIG. 7 is a flowchart diagram of a method of tracking data readiness for load operations with a counter.

FIG. 8 is a flowchart diagram of a method of tracking data readiness for segmented load operations with a counter.

FIG. 9 is a flowchart diagram of a method of tracking data readiness for store operations with a counter.

### DETAILED DESCRIPTION

A processor or processor core may execute instructions in a pipeline based on the microarchitecture that is implemented. The pipeline may be implemented by various components, such as decode units, rename units, dispatch units, execution units, registers, caches, queues, data paths, and/or other logic associated with instruction flow. In implementations, the processor may support out-of-order operation. This means that data moving from one component to another component in the processor may not be provided in the order expected or needed. This can lead to issues such as determining whether the data tagged as “last” data is actually the last piece of data or was just received out-of-order with respect to other pieces of data. This can lead to issues for certain types of vector instructions, such as a segmented load or segmented store instruction, which need all the data for proper execution.

Described are methods and circuitry to track data readiness for load store operations. A counter is provided for each valid entry in a load transfer buffer (LTB) or a store transfer buffer (STB). The counter is initialized with the expected number of writes or the expected number of micro-operations that can update the LTB or STB entry, respectively. Each occurrence of an update, results in decrementing the counter. In general, when the counter is at zero, a micro-operation is awakened to execute using the now available data.

In implementations, the counter can be repurposed for segmented load completion tracking. In this instance, the awakened micro-operation is the first of a set of segmented load micro-operations cracked from a vector instruction. The first segmented load micro-operation (e.g., first issued segmented load micro-operation) initializes the counter at the associated LTB entry with the number of expected segmented load micro-operations. This will keep track of how many segmented load micro-operations have completed the operation. The counter is decremented at each completion. All LTB entries are released when the counter is zero.

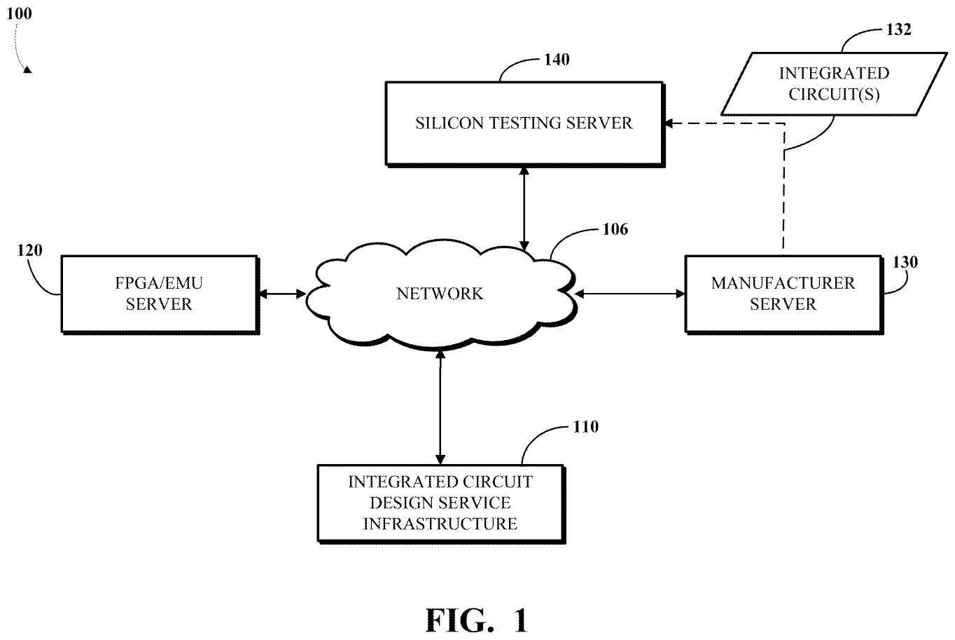

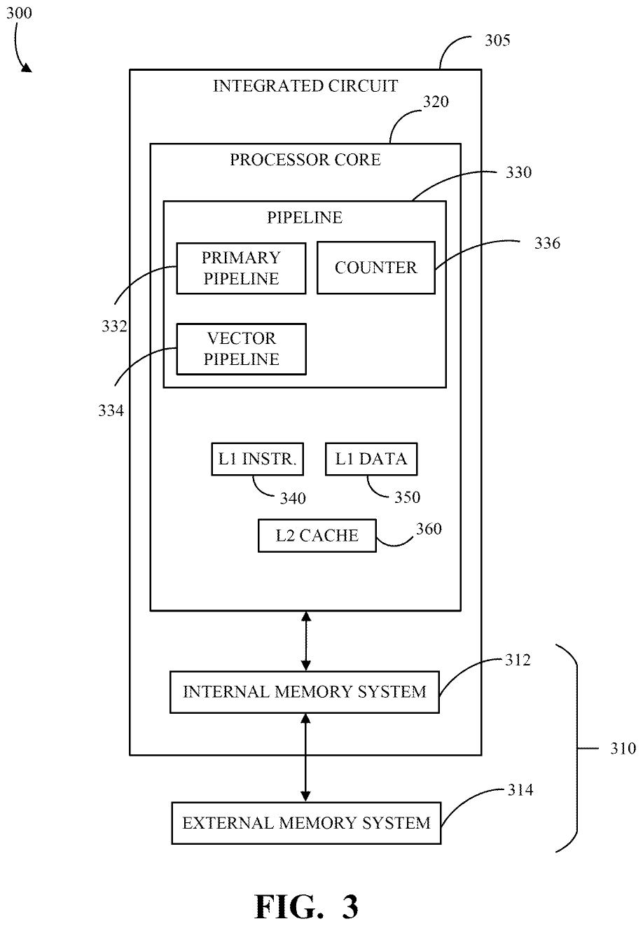

To describe some implementations in greater detail, reference is first made to examples of hardware and software structures used to implement a system including components that may incorporate the mechanism of tracking of data readiness for load and store operations. FIG. 1 is a block diagram of an example of a system 100 for generation and manufacture of integrated circuits. The system 100 includes a network 106, an integrated circuit design service infrastructure 110 (e.g., integrated circuit generator), a field programmable gate array (FPGA)/emulator server 120, and a manufacturer server 130. For example, a user may utilize a web client or a scripting application program interface (API) client to command the integrated circuit design service infrastructure 110 to automatically generate an integrated circuit design based on a set of design parameter values selected by the user for one or more template integrated circuit designs. In some implementations, the integrated circuit design service infrastructure 110 may be configured to generate an integrated circuit design like the integrated circuit design shown and described in FIGS. 3-6.

The integrated circuit design service infrastructure 110 may include a register-transfer level (RTL) service module configured to generate an RTL data structure for the integrated circuit based on a design parameters data structure. For example, the RTL service module may be implemented as Scala code. For example, the RTL service module may be implemented using Chisel. For example, the RTL service module may be implemented using flexible intermediate representation for register-transfer level (FIRRTL) and/or a FIRRTL compiler. For example, the RTL service module may be implemented using Diplomacy. For example, the RTL service module may enable a well-designed chip to be automatically developed from a high level set of configuration settings using a mix of Diplomacy, Chisel, and FIRRTL. The RTL service module may take the design parameters data structure (e.g., a java script object notation (JSON) file) as input and output an RTL data structure (e.g., a Verilog file) for the chip.

In some implementations, the integrated circuit design service infrastructure 110 may invoke (e.g., via network communications over the network 106) testing of the resulting design that is performed by the FPGA/emulation server 120 that is running one or more FPGAs or other types of hardware or software emulators. For example, the integrated circuit design service infrastructure 110 may invoke a test using a field programmable gate array, programmed based on a field programmable gate array emulation data structure, to obtain an emulation result. The field programmable gate array may be operating on the FPGA/emulation server 120, which may be a cloud server. Test results may be returned by the FPGA/emulation server 120 to the integrated circuit design service infrastructure 110 and relayed in a useful format to the user (e.g., via a web client or a scripting API client).

The integrated circuit design service infrastructure 110 may also facilitate the manufacture of integrated circuits using the integrated circuit design in a manufacturing facility associated with the manufacturer server 130. In some implementations, a physical design specification (e.g., a graphic data system (GDS) file, such as a GDSII file) based on a physical design data structure for the integrated circuit is transmitted to the manufacturer server 130 to invoke manufacturing of the integrated circuit (e.g., using manufacturing equipment of the associated manufacturer). For example, the manufacturer server 130 may host a foundry tape-out website that is configured to receive physical design specifications (e.g., such as a GDSII file or an open artwork system interchange standard (OASIS) file) to schedule or otherwise facilitate fabrication of integrated circuits. In some implementations, the integrated circuit design service infrastructure 110 supports multi-tenancy to allow multiple integrated circuit designs (e.g., from one or more users) to share fixed costs of manufacturing (e.g., reticle/mask generation, and/or shuttles wafer tests). For example, the integrated circuit design service infrastructure 110 may use a fixed package (e.g., a quasi-standardized packaging) that is defined to reduce fixed costs and facilitate sharing of reticle/mask, wafer test, and other fixed manufacturing costs. For example, the physical design specification may include one or more physical designs from one or more respective physical design data structures in order to facilitate multi-tenancy manufacturing.

In response to the transmission of the physical design specification, the manufacturer associated with the manufacturer server 130 may fabricate and/or test integrated circuits based on the integrated circuit design. For example, the associated manufacturer (e.g., a foundry) may perform optical proximity correction (OPC) and similar post-tape-out/pre-production processing, fabricate the integrated circuit(s) 132, update the integrated circuit design service infrastructure 110 (e.g., via communications with a controller or a web application server) periodically or asynchronously on the status of the manufacturing process, perform appropriate testing (e.g., wafer testing), and send to a packaging house for packaging. A packaging house may receive the finished wafers or dice from the manufacturer and test materials and update the integrated circuit design service infrastructure 110 on the status of the packaging and delivery process periodically or asynchronously. In some implementations, status updates may be relayed to the user when the user checks in using the web interface, and/or the controller might email the user that updates are available.

In some implementations, the resulting integrated circuit(s) 132 (e.g., physical chips) are delivered (e.g., via mail) to a silicon testing service provider associated with a silicon testing server 140. In some implementations, the resulting integrated circuit(s) 132 (e.g., physical chips) are installed in a system controlled by the silicon testing server 140 (e.g., a cloud server), making them quickly accessible to be run and tested remotely using network communications to control the operation of the integrated circuit(s) 132. For example, a login to the silicon testing server 140 controlling a manufactured integrated circuit(s) 132 may be sent to the integrated circuit design service infrastructure 110 and relayed to a user (e.g., via a web client). For example, the integrated circuit design service infrastructure 110 may be used to control testing of one or more integrated circuit(s) 132.

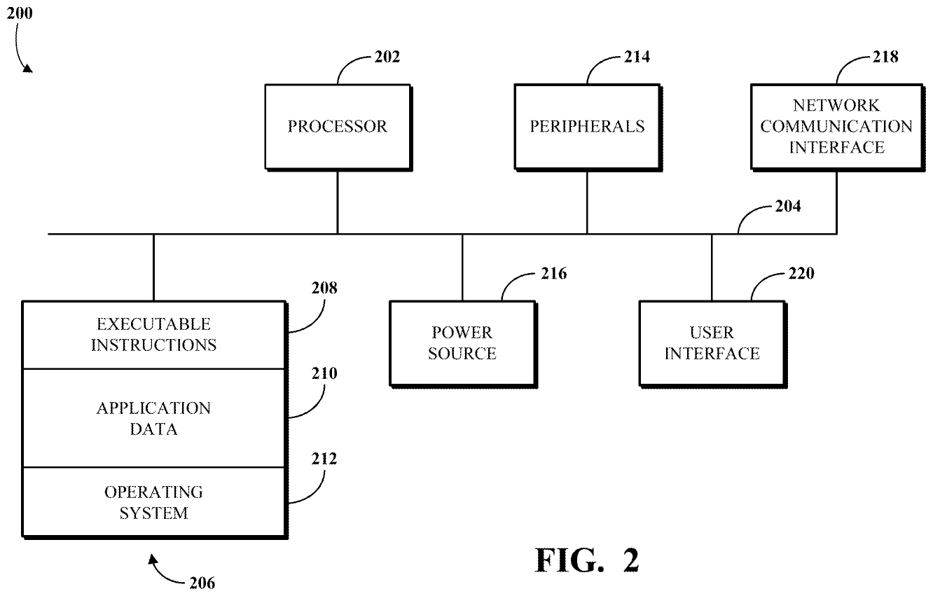

FIG. 2 is a block diagram of an example of a system 200 for facilitating generation of integrated circuits, for facilitating generation of a circuit representation for an integrated circuit, and/or for programming or manufacturing an integrated circuit. The system 200 is an example of an internal configuration of a computing device. The system 200 may be used to implement the integrated circuit design service infrastructure 110, and/or to generate a file that generates a circuit representation of an integrated circuit design like the integrated circuit design shown and described in FIGS. 3-6. The processor 202 can be a central processing unit (CPU), such as a microprocessor, and can include single or multiple processors having single or multiple processing cores. Alternatively, the processor 202 can include another type of device, or multiple devices, now existing or hereafter developed, capable of manipulating or processing information. For example, the processor 202 can include multiple processors interconnected in any manner, including hardwired or networked, including wirelessly networked. In some implementations, the operations of the processor 202 can be distributed across multiple physical devices or units that can be coupled directly or across a local area or other suitable type of network. In some implementations, the processor 202 can include a cache, or cache memory, for local storage of operating data or instructions.

The memory 206 can include volatile memory, non-volatile memory, or a combination thereof. For example, the memory 206 can include volatile memory, such as one or more dynamic random access memory (DRAM) modules such as double data rate (DDR) synchronous DRAM (SDRAM), and non-volatile memory, such as a disk drive, a solid-state drive, flash memory, Phase-Change Memory (PCM), or any form of non-volatile memory capable of persistent electronic information storage, such as in the absence of an active power supply. The memory 206 can include another type of device, or multiple devices, now existing or hereafter developed, capable of storing data or instructions for processing by the processor 202. The processor 202 can access or manipulate data in the memory 206 via the bus 204. Although shown as a single block in FIG. 2, the memory 206 can be implemented as multiple units. For example, a system 200 can include volatile memory, such as random access memory (RAM), and persistent memory, such as a hard drive or other storage.

The memory 206 can include executable instructions 208, data, such as application data 210, an operating system 212, or a combination thereof, for immediate access by the processor 202. The executable instructions 208 can include, for example, one or more application programs, which can be loaded or copied, in whole or in part, from non-volatile memory to volatile memory to be executed by the processor 202. The executable instructions 208 can be organized into programmable modules or algorithms, functional programs, codes, code segments, or combinations thereof to perform various functions described herein. For example, the executable instructions 208 can include instructions executable by the processor 202 to cause the system 200 to automatically, in response to a command, generate an integrated circuit design and associated test results based on a design parameters data structure. The application data 210 can include, for example, user files, database catalogs or dictionaries, configuration information or functional programs, such as a web browser, a web server, a database server, or a combination thereof. The operating system 212 can be, for example, Microsoft Windows®, macOS®, or Linux®; an operating system for a small device, such as a smartphone or tablet device; or an operating system for a large device, such as a mainframe computer. The memory 206 can comprise one or more devices and can utilize one or more types of storage, such as solid-state or magnetic storage.

The peripherals 214 can be coupled to the processor 202 via the bus 204. The peripherals 214 can be sensors or detectors, or devices containing any number of sensors or detectors, which can monitor the system 200 itself or the environment around the system 200. For example, a system 200 can contain a temperature sensor for measuring temperatures of components of the system 200, such as the processor 202. Other sensors or detectors can be used with the system 200, as can be contemplated. In some implementations, the power source 216 can be a battery, and the system 200 can operate independently of an external power distribution system. Any of the components of the system 200, such as the peripherals 214 or the power source 216, can communicate with the processor 202 via the bus 204.

The network communication interface 218 can also be coupled to the processor 202 via the bus 204. In some implementations, the network communication interface 218 can comprise one or more transceivers. The network communication interface 218 can, for example, provide a connection or link to a network, such as the network 106 shown in FIG. 1, via a network interface, which can be a wired network interface, such as Ethernet, or a wireless network interface. For example, the system 200 can communicate with other devices via the network communication interface 218 and the network interface using one or more network protocols, such as Ethernet, transmission control protocol (TCP), Internet protocol (IP), power line communication (PLC), Wi-Fi, infrared, general packet radio service (GPRS), global system for mobile communications (GSM), code division multiple access (CDMA), or other suitable protocols.

A user interface 220 can include a display; a positional input device, such as a mouse, touchpad, touchscreen, or the like; a keyboard; or other suitable human or machine interface devices. The user interface 220 can be coupled to the processor 202 via the bus 204. Other interface devices that permit a user to program or otherwise use the system 200 can be provided in addition to or as an alternative to a display. In some implementations, the user interface 220 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 214. The operations of the processor 202 can be distributed across multiple clients or servers, which can be coupled directly or across a local area or other suitable type of network. The memory 206 can be distributed across multiple clients or servers, such as network-based memory or memory in multiple clients or servers performing the operations of clients or servers. Although depicted here as a single bus, the bus 204 can be composed of multiple buses, which can be connected to one another through various bridges, controllers, or adapters.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In some implementations, the circuit representation may take the form of a hardware description language (HDL) program, a register-transfer level (RTL) data structure, a flexible intermediate representation for register-transfer level (FIRRTL) data structure, a Graphic Design System II (GDSII) data structure, a netlist, or a combination thereof. In some implementations, the integrated circuit may take the form of a field programmable gate array (FPGA), application specific integrated circuit (ASIC), system-on-a-chip (SoC), or some combination thereof. A computer may process the circuit representation in order to program or manufacture an integrated circuit, which may include programming a field programmable gate array (FPGA) or manufacturing an application specific integrated circuit (ASIC) or a system on a chip (SoC). In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming.

In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit.

In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

FIG. 3 is a block diagram of an example of an integrated circuit 300 including a primary pipeline, a vector pipeline, and a counter 336. The integrated circuit 305 may include a processor core 320. The integrated circuit 305 could be implemented, for example, as a field-programmable gate array (FPGA), an application-specific integrated circuit (ASIC), or a system-on-chip (SoC). The memory system 310 may include an internal memory system 312 and an external memory system 314. The internal memory system 312 may be in communication with the external memory system 314. The internal memory system 312 may be internal to the integrated circuit 305 (e.g., implemented by the FPGA, the ASIC, or the SoC). The external memory system 314 may be external to integrated circuit 305 (e.g., not implemented by the FPGA, the ASIC, or the SoC). The internal memory system 312 may include, for example, a controller and memory, such as random access memory (RAM), static random access memory (SRAM), cache, and/or a cache controller, such as a level three (L3) cache and an L3 cache controller. The external memory system 314 may include, for example, a controller and memory, such as dynamic random access memory (DRAM) and a memory controller. In some implementations, the memory system 310 may include memory mapped inputs and outputs (MMIO), and may be connected to non-volatile memory, such as a disk drive, a solid-state drive, flash memory, and/or phase-change memory (PCM).

The processor core 320 may include circuitry for executing instructions, such as one or more pipelines 330, a level one (L1) instruction cache 340, an L1 data cache 350, and a level two (L2) cache 360 that may be a shared cache. The processor core 320 may fetch and execute instructions in the one or more pipelines 330, for example, as part of a program sequence. The instructions may cause memory requests (e.g., read requests and/or write requests) that the one or more pipelines 330 may transmit to the L1 instruction cache 340, the L1 data cache 350, and/or the L2 cache 360.

Each of the one or more pipelines 330 may include a primary pipeline 332, a vector pipeline 334, and a counter 336. The primary pipeline 332 and the vector pipeline 334 each have separate decode units, rename units, dispatch units, execution units, physical and/or virtual registers, caches, queues, data paths, and/or other logic associated with instruction flow. The vector pipeline 334 may include one or more counters, such as the counter 336. In some implementations, the counter 336 can be the write counter associated with a LTB or STB entry as described herein. For example, one or more LTB entries and/or STB entries may be equipped with counters such as the counter 336. For example, each and every LTB entries, and each and every STB entries may be individually equipped with the counters such as the counter 336. In some implementations, the primary pipeline 332 and the vector pipeline 334 may be out-of-order pipelines. The integrated circuit 300 and each component in the integrated circuit 300 is illustrative and can include additional, fewer, or different components which may be similarly or differently architected without departing from the scope of the specification and claims herein. Moreover, the illustrated components can perform other functions without departing from the scope of the specification and claims herein.

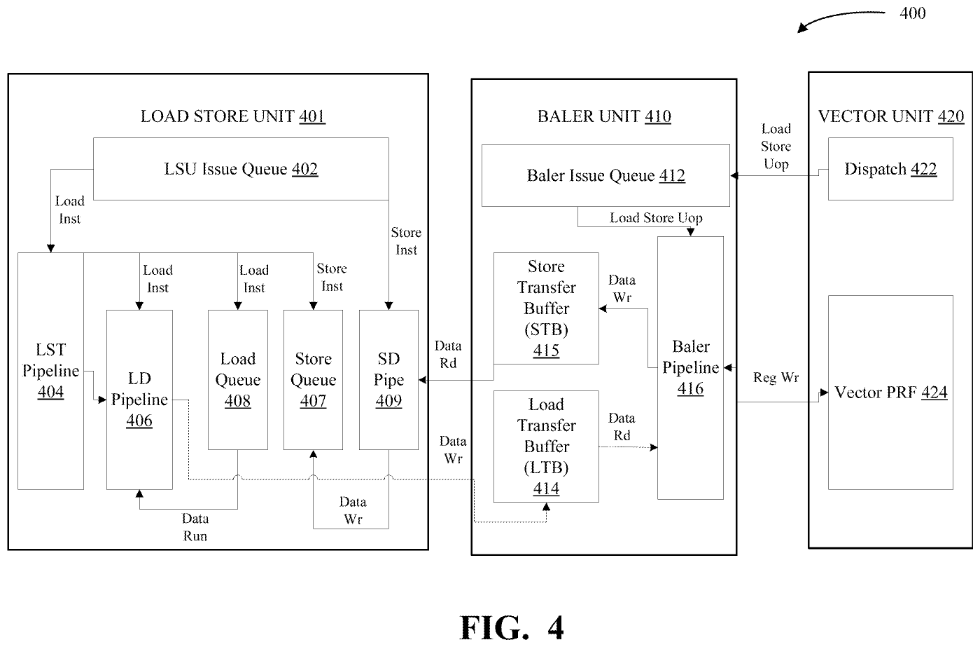

FIG. 4 is a block diagram illustrating a relationship between a load store unit (LSU) 401, a Baler unit (Baler) 410, and a Vector Unit or Processor (VU) 420. The block diagram 400 and its components (e.g., LSU, Baler, VU) can be implemented, for example, by a processor, such as the processor core 320, a pipeline, such as the pipeline 330, the primary pipeline 332, and the vector pipeline 334, the counter 336, and/or a circuitry that incorporates a mechanism of tracking of data readiness for load and store operations.

The LSU may include an LSU issue queue 402, a LST pipeline 404, a LD pipeline 406, a load queue 408, a store queue 407, and a SD pipeline 409. The Baler 410 may include a store transfer buffer (STB) 415, a load transfer buffer (LTB) 414, a Baler pipeline 416, and a Baler issue queue 412. The VU may include a dispatch unit 422 and vector and mask physical register files (Vector PRFs) 424.

The LSU 401 may load data from memory and prepare it for processing by the VU 420. By writing the data to the Load Transfer Buffer (LTB) 414, the LSU 401 may efficiently transfer data to the VU 420 for processing, without slowing down the LSU's ability to load more data from memory.

The LST pipeline 404 may be used to execute load instructions that involve data-dependent memory operations. These operations may require the LSU 401 to access the memory multiple times in order to retrieve the necessary data. The LST pipeline 404 may include stages for issuing the instruction, checking for hazards, performing memory access, and writing back the result.

The LD pipeline 406, on the other hand, may be used to execute simple load instructions that do not require multiple memory accesses. Such instructions can be executed more quickly than those that involve data-dependent memory operations. The LD pipeline 406 may include stages for issuing the instruction, checking for hazards, performing memory access, and writing back the result.

The SD pipeline 409 may be used to execute store instructions. The SD pipeline 409 may take store instructions from the LSU issue queue 402 and may process them through stages, similar to the LD pipeline 406. The SD pipeline 409 may write data to the store queue, or in some cases, directly to the memory hierarchy (e.g., cache, main memory).

The Baler 410 may include the Baler issue queue 412, the LTB 414, the STB 415, and the Baler pipeline 416. The Baler 410 may be an intermediate buffer between the LSU 401 and the VU 420. The Baler 410 may buffer the load data from the LSU 401 and the store data from VU 420. Further, the Baler 410 may manage the timing and coordination of operations or micro-operations (uops) with other components, such as the LSU 401, the LTB 414, and/or the STB 415. The tracking of data readiness may be done in the Baler 410 to wake-up the LSU 401 or VU 420 once the data is ready to be accessed.

The LTB 404 is the load buffer in Baler that handles the load data. Each LTB entry stores VLEN-wide data read from memory, where VLEN is the vector register width in bits. For each non-segmented load element, the LTB may load to the same place in a LTB entry (like where it should in a vector register). For each segmented load element, the LTB may load the segments in an in-memory format (segments of an element are placed sequentially).

The STB 415 is the store buffer in the Baler that handles the store data. Each STB entry stores VLEN-wide data read from the Vector PRFs 424. For each non-segmented store, the vector PRF content is copied directly to the STB entry. For segmented store, the STB 415 stores the segments in an in-memory format (segments of an element are placed sequentially).

Baler issue queue 412, on the other hand, may be used to temporarily store operations or uops that have been issued by the VU 420 for execution. Further, the Baler pipeline 416 may be a type of pipeline used in the execution or support of the execution of vector instructions, or vector, scalar, load, and/or store operations.

The VU 420 may include the dispatch unit 422 and the Vector PRFs 424. The VU 420 may execute vector operations (e.g., vector uops) that have been issued by the processor. The dispatch unit 422 may communicate with and load vector uops to the Baler issue queue 412. The dispatch unit 422 may ensure coordination of the timing of uops to prevent conflict of resources and minimize stalls.

The Vector PRFs 424 may store temporary results and operands for the vector uops during their execution. The Vector PRFs 424 may hold the data elements being processed by the vector execution units and help manage register renaming and allocation for out-of-order execution. The Vector PRFs 424 may be designed to support the parallelism and high-throughput requirements of vector operations. The Vector PRFs may communicate with the Baler pipeline 416 with regards to Register Write.

As initially described, the processor may support out-of-order operation. This means that data moving from one component to another component in the processor may not be provided in the order expected or needed. This can lead to issues such as determining whether the data tagged as “last” data is actually the last piece of data or was just received out-of-order with respect to other pieces of data. This can lead to issues for certain types of vector instructions, such as a segmented load or segmented store instruction, which need all the data for proper execution.

A desirable system and technique for tracking data readiness for load store operations may be implemented with a counter, which may be provided or utilized for each valid entry in a load transfer buffer (LTB) or a store transfer buffer (STB). The counter may be utilized to track a number or progress of write data (or writes) that are expected to update the LTB entry or STB entry. Further, the counter may be repurposed (e.g., re-configured) for segmented load completion tracking.

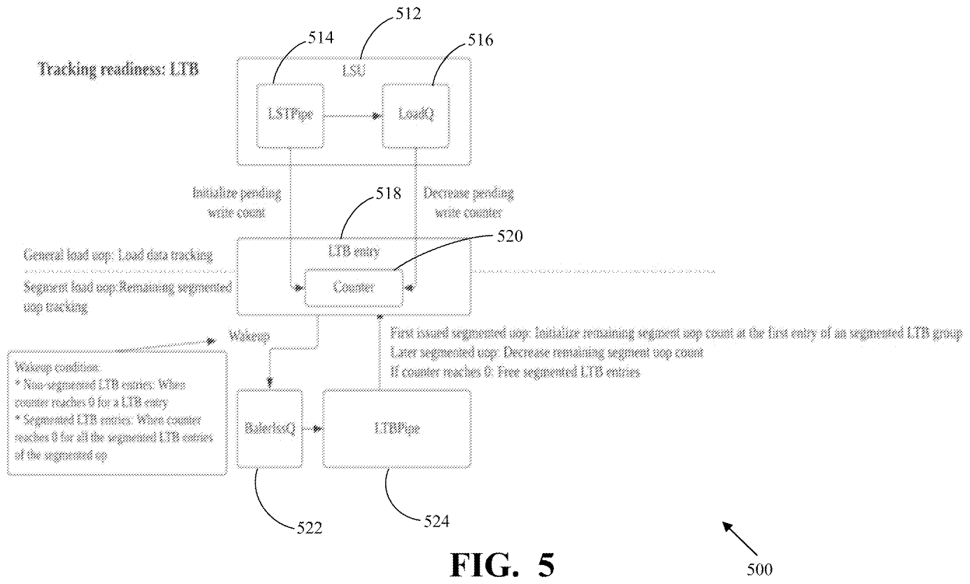

FIG. 5 is a block diagram 500 illustrating flow between elements in the LSU 512 and the Baler unit (such as the Baler 410) for LTB data readiness tracking. As described herein, a counter-based readiness tracking mechanism is implemented per LTB entry 518. The per-entry write counter 520 keeps track of the remaining writes that are expected from the LSU 512 to update the data in the LTB entry 518.

Operationally, when the LTB entry 518 is established by the LSU 512, the write counter 520 is initialized to the number of writes the LSU 512 is expected to update. For example, LST pipeline 514 of the LSU 512 may initialize the write counter 518 with a pending write count (e.g., the number of writes the LSU 512 is expected to update). The write counter 518 may maintain a current value until write data from the LSU 512 (e.g., from the Load queue 516 of the LSU 512) arrives, where the data could arrive out-of-order. For each received data, the write counter may be subtracted by 1. If the write counter reaches zero (0) or certain pre-determined number, the data in the LTB entry 518 is or is set as ready. The corresponding micro-operation (e.g., uop) in the Baler issue queue 522 may be awakened to consume the data in the LTB entry 518. This (e.g., establishing LTB entry, loading data to LTB entry, and utilizing the write counter to count the number of writes the LSU is expected to update) may be applied to both non-segmented load operations (e.g., micro-operations that comprise non-segmented load operation or correspond to a non-segmented load instruction) and segmented load operations (e.g., micro-operations that comprise segmented load operation or correspond to segmented load instruction). For non-segmented load operation, micro-operation is woken up (e.g., awakened) in Baler issue queue and after the micro-operation consumes the data in the LTB entry, the LTB entry is freed. On the other hand, for segmented load operation, multiple segmented load micro-operations (or all segmented load micro-operations that comprise a segmented load operation or correspond to a segmented load instruction) need to use data in multiple LTB entries that correspond to such multiple segmented load micro-operations to conduct (e.g., perform, go through) data transformation. As such, for segmented load operation, only when (or only after) last LTB entry (e.g., LTB data) of the LTB entries corresponding to the segmented load instruction or the segmented load operation is ready, corresponding micro-operations in Baler issue queue are woken up. Further, the write counter can be re-purposed (e.g., re-configured) to count a number of issued segmented load micro-operations that conduct data transformation or a progress of segmented load micro-operations that are expected to conduct or be involved in data transformation.

In implementations, the write counter can be re-purposed for segmented load completion tracking. As described above, for a segmented load, a data transformation datapath requires all the LTB entries of a segmented load instruction to be ready since the data for a vector register comes from multiple LTB entries. A different or separate segment wakeup logic senses the readiness of the LTB entries for the segmented load. This segment wakeup logic can awaken (e.g., wake up) the segmented micro-operations in the Baler issue queue 522 only when the last segment LTB entry's data is ready.

Operationally, the first issued segmented micro-operation may update the write counter at the first segmented load LTB entry (or first LTB entry for first issued segmented load micro-operation) with the pending segmented micro-operation count that is expected to complete the transformation. Subsequent issued segmented micro-operations that complete the transformation may subtract or decrement from the write counter at the first segmented load LTB entry. When the write counter reaches zero or certain pre-determined number, all of the segmented LTB entries can then be freed or released.

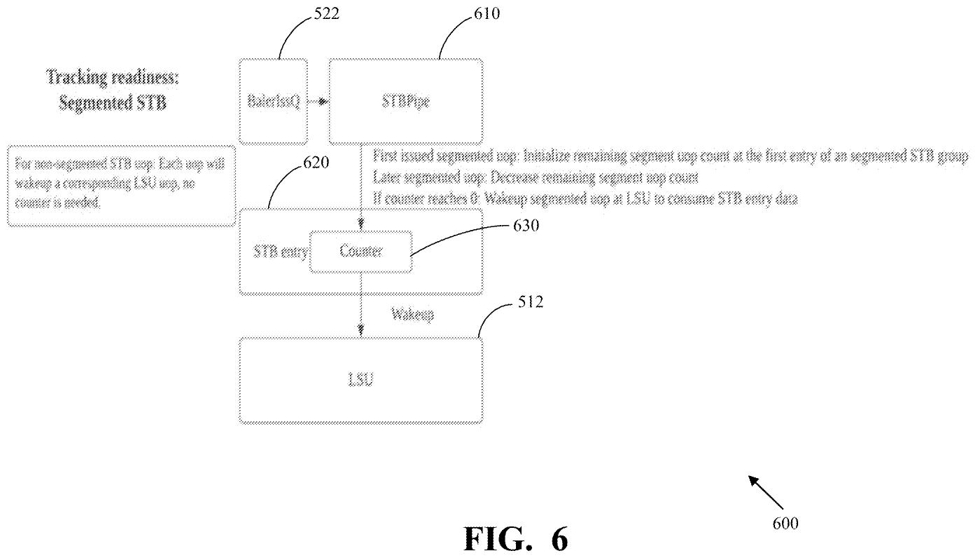

FIG. 6 is a block diagram 600 illustrating flow between elements in the LSU 512 and the Baler unit (such as the Baler 410) for STB data readiness tracking. Each segmented store micro-operation (e.g., uop) in the Baler unit can write to multiple STB entries. All segmented store micro-operations need to complete their write before the STB data is ready to be consumed and transmitted to vector registers by the LSU (or uop of LSU).

Operationally, a write counter 630 in the STB entry (e.g., a first STB entry 620) is similar to the LTB one. The first segmented store uop of a segmented store instruction may be awakened (e.g., woken up) at the Baler issue queue 522 and be sent to the STB pipeline 610 of the STB (such as the STB 415). The first segmented store uop may initialize or re-configure the write counter 630. For example, the first segmented store uop at the STB pipeline 610 may initialize the write counter 630 at the first STB entry 620 (e.g., first segmented store STB entry corresponding to the first issued segmented store uop) such that the respective write counter is re-configured (e.g., re-purposed) to reflect a segmented store completion tracking. Initializing the write counter 630 at the first STB entry 620 may be sufficient for segmented store completion tracking as each STB segmented store uop (corresponding to STB segmented store operation or segmented store instruction) may write to all STB entries (corresponding to STB segmented store operation or segmented store instruction). The segmented store completion tracking may track a remaining number or progress of segmented store uops that are expected to write STB data or update a respective STB entry. For example, the write counter 630 at the first STB entry 620 may be updated with a pending segmented store uop count which reflects or represents the remaining number of segmented store uops that are yet to write STB data or update the first STB entry 620.

As such, the write counter 630 may keep track of the segmented micro-operations that are yet to write to the STB entry. When the write counter 630 reaches zero, the STB data is ready. Accordingly, a micro-operation (e.g., uop) at the LSU 512 may be awakened to consume STB entry data and transmit the STB data to a memory.

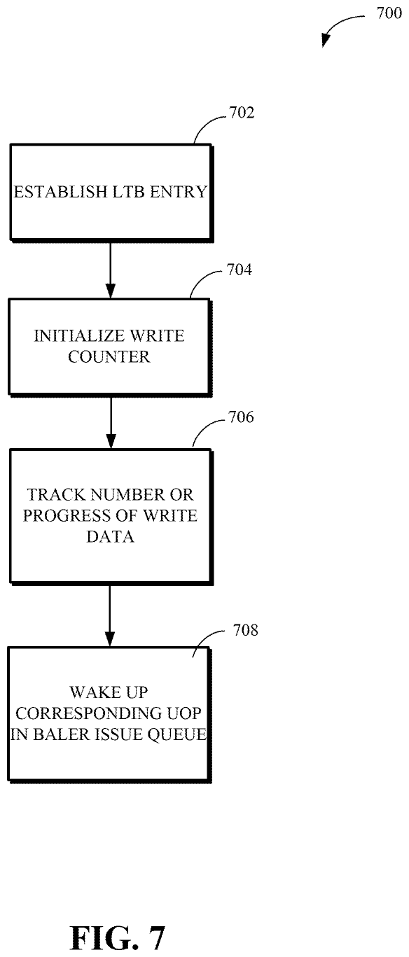

FIG. 7 is a flowchart diagram of a method 700 of tracking data readiness for load operations with a counter (e.g., write counter). The method 700 can be implemented, for example, by a processor, such as the processor 202, the processor core 320, a pipeline such as the pipeline 330, the counter 336, components or system in block diagrams 400 and 500, and/or any circuitry that may incorporate the LTB data readiness tracking as described above.

At 702, the method 700 establishes LTB entry. For example, the LTB entry may be established by the LSU.

At 704, the method 700 may initialize a write counter. For example, when the LTB entry is established, the write counter may be initialized to the number of writes LSU is expected to update. For example, the write counter may be configured to track a progress or number of write data (e.g., number of writes) that are expected to update the LTB entry or that the LSU is expected to update.

In some implementations, the write counter may be located in each of the LTB entry such that a respective write counter may be initialized to a respective number of writes LSU is expected to update for a respective LTB entry.

At 706, the method 700 may track a progress and/or number of write data or writes that are expected to update the LTB entry or that the LSU is expected to update. For example, the write data may arrive to the LTB entry in out-of-order such that the data moving from one component to another component in the processor may not be provided in the order expected or needed. As such, by tracking the progress and/or the number of write data that are expected to update the LTB entry or that the LSU is expected to update, the method 700 can determine a last piece of data of the data needed to update the LTB entry. Tracking the progress or number of write data may include setting the number of the write data that are expected to update the LTB entry (if this setting has not been performed during the initialization). Tracking the progress or number of write data may further include maintaining, until a next respective write data arrives to the LTB entry, a current value corresponding to a respective number of write data that is left to update the LTB entry. Further, the tracking may further include after receiving the next respective write data, adjusting (e.g., updating) the write counter to reflect a respective number of write data left to update the LTB entry. For example, the write counter to reflect the respective number of write data left to update the LTB entry may include subtracting the write counter by a numerical value of one for each received write data. For example, for each occurrence of an update, it may result in decrementing the counter.

At 708, the method 700 may wake up a corresponding uop in a baler issue queue. For example, when tracking is complete and necessary data to be consumed by a respective micro-operation (uop) is ready, the corresponding uop in the baler issue queue can be awakened (e.g., woken up). For example, when the current value of the write counter reaches zero or certain pre-determined value (that is set, programmed, or hardcoded), a micro-operation (e.g., uop in a baler issue queue) corresponding to a non-segmented load instruction may be awakened to execute using the now available data. For example, when the current value of the write counter reaches zero, the write counter, LSU, or the processor may indicate or transmit a signal representing that the data for the LTB entry is ready (e.g., no more write data is left to update the LTB entry, the update for the corresponding LTB entry is complete). For example, a system or a circuit that incorporates the method 700 may be programmed to wake up the corresponding uop corresponding to the non-segmented load instruction when the write counter reaches zero. For segmented load operation, each corresponding LTB entry may have a counter, and when all the LTB entries (e.g., LTB data) corresponding to the segmented load instruction is ready, respective segmented load uops that comprise segmented load operation or correspond to the segmented load instruction in the baler issue queue may be awakened.

After the corresponding uop(s) in the baler issue queue is awakened (e.g., woken up), the corresponding uop(s) may consume the data in the LTB entry.

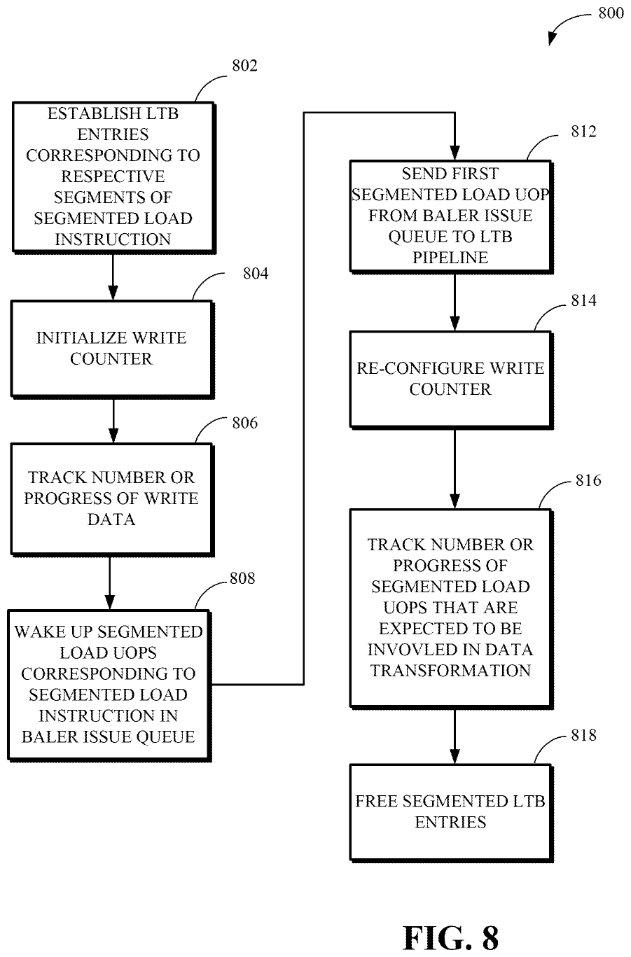

FIG. 8 is a flowchart diagram of a method 800 of tracking data readiness for segmented load operations with a counter. The method 700 can be implemented, for example, by a processor, such as the processor 202, the processor core 320, a pipeline such as the pipeline 330, the counter 336, components or system in block diagrams 400 and 500, and/or any circuitry that may incorporate the LTB data readiness and segmented load completion tracking. Moreover, the method 800 may be combined with the method 700 in any feasible manner in accordance with implementations of this disclosure.

At 802, the method 800 may establish LTB entries corresponding to a respective segments of segmented load instruction. For example, each LTB entry of the LTB entries may be established by the LSU.

At 804, the method 800 may initialize a write counter. For example, when a respective LTB entry is established, the write counter may be initialized to the number of writes the LSU is expected to update for the respective entry. For example, the write counter may be configured to track a progress or number of write data (e.g., number of writes) that are expected to update the respective LTB entry or that the LSU is expected to update. For example, the write counter may be a per-entry write counter such that there may be multiple writer counters, where each of the write counters is utilized for each LTB entry. Accordingly, each of the write counters corresponding to each LTB entry may be initialized.

At 806, the method 800 may track a progress or number of write data or writes that are expected to update the LTB entry or that the LSU is expected to update. For example, the write data may arrive to the LTB entry in out-of-order. Tracking the progress or number of write data may include setting the number of the write data that are expected to update the LTB entry (if this setting has not been performed during the initialization). Tracking the progress or number of write data may further include maintaining, until a next respective write data arrives to the LTB entry, a current value corresponding to a respective number of write data that is left to update the LTB entry. Further, the tracking may further include, after receiving the next respective write data, adjusting (e.g., updating) the write counter to reflect a respective number of write data left to update the LTB entry. For example, the write counter to reflect the respective number of write data left to update the LTB entry may include subtracting the write counter by a numerical value of one for each received write data. For example, for each occurrence of an update, it may result in decrementing the counter. The method 800 may conduct (e.g., perform) step 806 for all LTB entries that correspond to a segmented load instruction or segmented load operation. When a last LTB entry of the LTB entries corresponding to segmented load instruction is ready, the method 800 may proceed to step 808.

At 808, the method 800 may wake up corresponding micro-operation (e.g., uop) corresponding to the segmented load instruction (or segmented load operation) in a baler issue queue. For example, when the current value of the write counter reaches zero or certain pre-determined value (that is set, programmed, or hardcoded) for each LTB entry, and when all the LTB entries (e.g., LTB data) corresponding to the segmented load instruction is ready, a respective segmented load uops that comprise segmented load operation or correspond to the segmented load instruction in the baler issue queue may be awakened. For example, the write counter, LSU, or the processor may transmit a signal representing that the data for the LTB entries are ready (e.g., no more write data is left to update the LTB entry, the update for the corresponding LTB entries are complete). For example, a system or a circuit that incorporates the method 800 may be programmed to wake up the corresponding segmented load uops corresponding to the segmented load instruction.

At 812, the method 800 may send (e.g., issue) the first segmented load uop (of the segmented load uops that comprise the segmented load operation) from the baler issue queue to LTB pipeline of the LTB. Moreover, the method 800 may send (e.g., issue) other segmented load uops from the baler issue queue to the LTB pipeline of the LTB. This step may demonstrate that the first segmented load uop from the baler issue queue is first issued (over other segmented load uops) to the LTB pipeline in terms of timing.

At 814, the method 800 may re-configure the write counter at the first LTB entry. For example, the first segmented uop at the LTB pipeline may initialize a write counter at the first LTB entry (e.g., counter at first segmented LTB entry corresponding to the first segmented uop, the counter for the first LTB entry that was previously used for tracking number of write data or writes that are expected to update the LTB entry or that the LSU is expected to update) such that the respective write counter is re-configured (e.g., re-purposed) to reflect a segmented load completion tracking. The segmented load completion tracking may track a remaining number or progress of segmented load uops that are expected to do or be involved in data transformation. For example, the write counter (e.g., at the first LTB entry) may be updated with a pending segmented load uop count which reflects or represents the remaining number of segmented uops that are expected to do or be involved in the data transformation.

Moreover, in some implementations, other than initializing the write counter when the first segmented uop arrives at the LTB pipeline, timing of re-configuring the write counter may be based on a timing of when the first segmented uop is expected to be issued, or at the time of issuance, or at certain pre-determined timing after it is issued. For example, a system or a circuit that incorporates the method 800 may be programmed to re-configure a respective write counter according to such timing.

At 816, the method 800 may track the remaining number or progress of segmented uops that are expected to do or be involved in data transformation. For example, tracking the number or the progress of the segmented uops that are expected to be involved in the data transformation may include adjusting (or updating) the write counter (or pending segment uop count in the write counter) to reflect a respective number of segmented uops that are left to do or be involved in the data transformation. For example, adjusting (or updating) the write counter (or pending segmented uop count) may include subtracting the write counter by a numerical value of one for each issued segmented uop that completes the data transformation.

At 818, the method 800 may free (e.g., liberate) respective LTB entries that are allocated by or corresponding to the segmented load instruction. For example, after data in the LTB entries are consumed by the segmented load uops, the LTB entries may be freed or liberated.

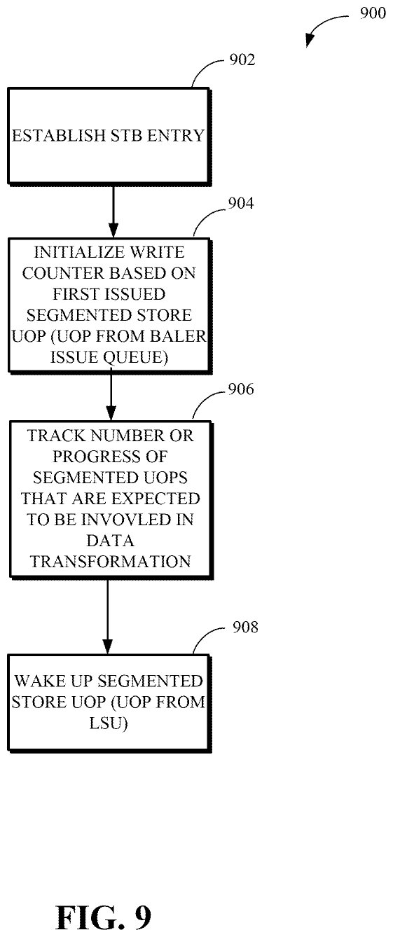

FIG. 9 is a flowchart diagram of a method 900 of tracking data readiness for store operations with a counter. The method 900 can be implemented, for example, by a processor, such as the processor 202, the processor core 320, a pipeline such as the pipeline 330, the counter 336, components or system in block diagrams 400, 500, and 600, and/or any circuitry that may incorporate the STB data readiness tracking. Moreover, the method 900 may be combined with the method 700 and/or the method 800 in feasible manner in accordance with implementations of this disclosure.

Each segmented uop in Baler can write to multiple STB entries. All the segmented uops need to complete their writes before STB data is ready to be consumed by the LSU.

At 902, the method 900 may establish STB entry. For example, the STB entry (e.g., segmented STB entry corresponding to a segmented store instruction) of the STB may be established by the Baler unit (e.g., the Baler 410).

At 904, the method 900 may initialize or re-configure a write counter (at the first STB entry) based on a first segmented store uop (e.g., first issued segmented store uop) corresponding to the segmented store instruction. For example, the first segmented store uop may be awakened (e.g., woken up) at a Baler issue queue and be sent to the STB pipeline of the STB. The segmented store instruction may have fetched and decoded previously such that the first segmented uop and other segmented uops that comprise a segmented store uop group (or segmented store operation or correspond to the segmented store instruction) may be at the Baler issue queue.

For example, the first segmented store uop at the STB pipeline may initialize a write counter at a first STB entry (e.g., first segment STB entry corresponding to the first segmented uop) such that the write counter is configured to reflect a segmented store completion tracking. The segmented store completion tracking may track a remaining number or progress of segmented uops that are expected to write STB data or update a respective STB entry. For example, the write counter at the first STB entry may be updated with a pending segmented uop count which reflects or represents the remaining number of segmented uops that are yet to write STB data or update the first STB entry.

At 906, the method 900 may track a remaining number or progress of segmented uops that are expected to write STB data or update the respective STB entry. For example, the write data (e.g., from segmented store uops that are awakened at the Baler issue queue and being issued to the STB pipeline) may arrive to the STB entry in out-of-order. As such, by performing segmented store completion tracking, the method 900 can determine a last issued segmented store uop to write STB data or update the STB entry.

For example, tracking the remaining number or the progress of the segmented uops that are expected to write STB data or update the respective STB entry may include adjusting (or updating) the write counter (or pending segment uop count in the write counter) to reflect a respective number of segmented store uops that are expected to write STB data or update the respective STB entry. For example, adjusting (or updating) the write counter (or pending segmented uop count) may include subtracting the write counter by a numerical value of one for each issued segmented uop that are expected to write STB data or update the respective STB entry.

At 908, the method 900 may wake up a corresponding uop in LSU to consume or write STB data to memory. For example, when the current value of the write counter reaches zero or certain pre-determined value (that is set, programmed, or hardcoded), a micro-operation (e.g., uop in LSU) may be awakened to execute using the now available data. For example, when the current value of the write counter reaches zero, the write counter, STB, or the processor may indicate or transmit a signal representing that the data for the STB entry is ready. For example, a system or a circuit that incorporates the method 900 may be programmed to wake up the corresponding store uop in LSU, which corresponds to the segmented store instruction, when the write counter reaches zero. After the corresponding store operation or uop in the baler issue queue is awakened, the corresponding uop may consume and transmit STB data to memory. Moreover, as described above, all the segmented uops need to complete their writes to the STB entries before STB data is ready to be consumed and transmitted to a memory by the LSU uop.

The described methods and systems include a method for tracking of data readiness for load operations. The method includes establishing an Load Transfer Buffer (LTB) entry corresponding to a load instruction; initializing a write counter that is configured to track a number or progress of write data or writes that are expected to update the LTB entry; tracking the number or progress of the write data that are expected to update the LTB entry; and when tracking is complete and necessary data to be consumed by a respective micro-operation (uop) is ready, waking up the respective uop corresponding to the load instruction in a Baler issue queue. In implementations, the method can further include consuming, through the respective uop, a data in the LTB entry. In implementations, the method can further include issuing the first segmented uop of segmented load uops corresponding to the segmented load instruction from the Baler issue queue to an LTB pipeline; and re-configuring, based on the first segmented uop, the write counter at the first LTB entry such that the write counter is configured to track a remaining number or a progress of the segmented load uops that are expected to be involved in data transformation. In implementations, the method can further include tracking the remaining number or the progress of segmented uops that are expected to be involved in the data transformation. In implementations, the method can further include when the respective number of the segmented uops that are left to be involved reaches zero, freeing all LTB entries corresponding to the segmented load instruction.

In implementations the tracking the number of progress of the write data that are expected to update the LTB entry includes setting, in the write counter, the number of the write data that are expected to update the LTB entry; maintaining, until a next respective write data arrives to the LTB entry, a current value corresponding to a respective number of write data left to update the LTB entry; and after receiving the next respective write data, adjusting the write counter to reflect a respective number of write data left to update the LTB entry.

In implementations, adjusting the write counter to reflect the respective number of write data left to update the LTB entry includes subtracting the write counter by a numerical value of one for each received write data.

In implementations, at least some of the write data arrives to the LTB entry is out-of-order.

In implementations, the load instruction corresponds to a segmented load instruction; the respective uop corresponding to the load instruction in the Baler issue queue is a first segmented uop corresponding to the segmented load instruction; the respective uop is woken up only after all LTB entries that correspond to the segmented load instruction are updated and ready to be consumed; and the write counter is positioned at a first LTB entry.

In implementations, re-configuring the write counter includes, based on the first segmented uop, updating the write counter with a pending segmented uop count representing the remaining number of the segmented uops that are expected to be involved in the data transformation.

In implementations, tracking the remaining number or the progress of the segments uops that are expected to be involved in the data transformation includes adjusting the write counter to reflect a respective number of segmented uops that are left to be involved in the data transformation.

The described methods and systems include a method that includes receiving Load Transfer Buffer (LTB) entries corresponding to a segmented load instruction; initializing write counters, wherein each of the write counters is configured to track a number or progress of write data that are expected to update a respective LTB entry of the LTB entries; tracking the number or progress of the write data that are expected to update the respective LTB entry; after all LTB entries that correspond to the segmented load instruction are updated and ready to be consumed, waking up corresponding segmented load micro-operations (uops) corresponding to the segmented load instruction in a Baler issue queue; and re-configuring the write counter such that the write counter is configured to track a remaining number or a progress of the segmented load uops that are expected to go through data transformation. In implementations, the method can further include issuing the first segmented uop from the Baler issue queue to a LTB pipeline and tracking the remaining number or the progress of the segmented uops that are expected to be involved in the data transformation.

In implementations, the re-configuring the write counter includes, based on the first issued segmented uop of the corresponding segmented load uops, initializing the write counter with a pending segmented uop count representing the number of the segmented uops that are expected to be involved in the data transformation.

In implementations, the tracking the number or the progress of the segmented uops that are expected to be involved in the data transformation includes adjusting the write counter to reflect a respective number of segmented uops that are left to be involved in the data transformation.

In implementations, the adjusting the write counter to reflect the respective number of the segmented uops that are left to be involved in the data transformation includes subtracting the write counter by a numerical value of one for each issued segmented uop that completed the data transformation.

The described methods and systems include a system for tracking of data readiness for load operations. The system can include a Baler Unit comprising a Baler issue queue and Load Transfer Buffer (LTB); a Load Store Unit (LSU) configured to establish LTB entries corresponding to respective segments of a segmented load instruction; a Vector Processing Unit (VU) configured to dispatch micro-operations (uops) to the Baler issue queue; one or more write counters; and a processor. The processor is configured to execute instructions to: initialize one or more write counters, wherein respective write counter of the one or more write counters is configured to track a number or progress of write data that are expected to update a respective LTB entry of the LTB entries; track, using the respective write counter, the number or progress of the write data that are expected to update the respective LTB entry; after all of the LTB entries corresponding to a segmented load instruction are updated and ready to be consumed, wake up one or more segmented load uops corresponding to the segmented load instruction in the Baler issue queue; and re-configure, based on a first segmented load uop of the one or more segmented load uops, the write counter such that the write counter is configured to track a remaining number or a progress of segmented load uops that are expected to go through data transformation. In implementations, the processor can be further configured to execute the instructions to send (or issue) the first segmented load uop from the Baler issue queue to an LTB pipeline of the LTB and track the remaining number or the progress of the segmented load uops that are expected to be involved in the data transformation.

In implementations, to re-configure the write counter includes to: based on the first issued segmented uop, initialize the write counter with a pending segmented uop count representing the number of the segmented uops that are expected to be involved in the data transformation.

In implementations, to update the write counter further includes to: adjust the pending segmented uop count to reflect respective number of the segmented uops that are left to be involved in the data transformation, wherein adjusting includes subtracting the write counter by a numerical value of one for each issued segmented uop that completed the data transformation.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. A method for tracking of data readiness for load operations, comprising:
establishing a Load Transfer Buffer (LTB) entry corresponding to a load instruction;
initializing a write counter, wherein the write counter is configured to track a number or progress of write data or writes that are expected to update the LTB entry;
tracking, via the write counter, the number or progress of the write data that are expected to update the LTB entry; and
when tracking is complete and necessary data to be consumed by a respective micro-operation (uop) is ready, waking up the respective uop corresponding to the load instruction in a Baler issue queue.

2. The method of claim 1, wherein the tracking the number or progress of the write data that are expected to update the LTB entry comprises:
setting, in the write counter, the number of the write data that are expected to update the LTB entry;
maintaining, until a next respective write data arrives to the LTB entry, a current value corresponding to a respective number of write data left to update the LTB entry; and
after receiving the next respective write data, adjusting the write counter to reflect a respective number of write data left to update the LTB entry.

3. The method of claim 2, further comprising:
consuming, through the respective uop, a data in the LTB entry.

4. The method of claim 2, wherein adjusting the write counter to reflect the respective number of write data left to update the LTB entry includes subtracting the write counter by a numerical value of one for each received write data.

5. The method of claim 2, wherein at least some of the write data arrives to the LTB entry is out-of-order.

6. The method of claim 2, wherein:
the load instruction corresponds to a segmented load instruction;
the respective uop corresponding to the load instruction in the Baler issue queue is a first segmented uop corresponding to the segmented load instruction;
the respective uop is woken up only after all LTB entries that correspond to the segmented load instruction are updated and ready to be consumed; and
the write counter is positioned at a first LTB entry; and
the method further comprises:
issuing the first segmented uop of segmented load uops corresponding to the segmented load instruction from the Baler issue queue to an LTB pipeline; and
re-configuring, based on the first segmented uop, the write counter at the first LTB entry such that the write counter is configured to track a remaining number or a progress of the segmented load uops that are expected to be involved in data transformation.

7. The method of claim 6, further comprising:
tracking the remaining number or the progress of segmented uops that are expected to be involved in the data transformation.

8. The method of claim 7, wherein re-configuring the write counter includes:
based on the first segmented uop, updating the write counter with a pending segmented uop count representing the remaining number of the segmented uops that are expected to be involved in the data transformation.

9. The method of claim 8, wherein tracking the remaining number or the progress of the segments uops that are expected to be involved in the data transformation includes adjusting the write counter to reflect a respective number of segmented uops that are left to be involved in the data transformation.

10. The method of claim 9, wherein adjusting the write counter to reflect the respective number of the segmented uops that are left to be involved in the data transformation includes subtracting the write counter by a numerical value of one for each issued segmented uop that completed the data transformation.

11. The method of claim 10, further comprising:
when the respective number of the segmented uops that are left to be involved reaches zero, freeing all LTB entries corresponding to the segmented load instruction.

12. A method comprising:
receiving Load Transfer Buffer (LTB) entries corresponding to a segmented load instruction;
initializing write counters, wherein each of the write counters is configured to track a number or progress of write data that are expected to update a respective LTB entry of the LTB entries;
tracking, via a respective write counter of the write counters, the number or progress of the write data that are expected to update the respective LTB entry;
after all LTB entries that correspond to the segmented load instruction are updated and ready to be consumed, waking up corresponding segmented load micro-operations (uops) corresponding to the segmented load instruction in a Baler issue queue; and
re-configuring a write counter at a first LTB entry of all the LTB entries such that the write counter at the first LTB entry is configured to track a remaining number or a progress of the segmented load uops that are expected to go through data transformation.

13. The method of claim 12, further comprising:
issuing the first segmented uop from the Baler issue queue to a LTB pipeline; and
tracking the remaining number or the progress of the segmented uops that are expected to be involved in the data transformation.

14. The method of claim 13, wherein the re-configuring the write counter at the first LTB entry of all the LTB entries includes:
based on the first issued segmented uop of the corresponding segmented load uops, initializing the write counter at the first LTB entry with a pending segmented uop count representing the number of the segmented uops that are expected to be involved in the data transformation.

15. The method of claim 14, wherein tracking the number or the progress of the segmented uops that are expected to be involved in the data transformation includes adjusting the write counter at the first entry to reflect a respective number of segmented uops that are left to be involved in the data transformation.

16. The method of claim 15, wherein adjusting the write counter at the first entry to reflect the respective number of the segmented uops that are left to be involved in the data transformation includes subtracting the write counter by a numerical value of one for each issued segmented uop that completed the data transformation.

17. A system for tracking of data readiness for load operations, the system comprising:
a Baler Unit comprising a Baler issue queue and Load Transfer Buffer (LTB);
a Load Store Unit (LSU) configured to establish LTB entries corresponding to respective segments of a segmented load instruction;
a Vector Processing Unit (VU) configured to dispatch micro-operations (uops) to the Baler issue queue;
one or more write counters; and
a processor configured to execute instructions to:
initialize one or more write counters, wherein respective write counter of the one or more write counters is configured to track a number or progress of write data that are expected to update a respective LTB entry of the LTB entries;
track, using the respective write counter, the number or progress of the write data that are expected to update the respective LTB entry;
after all of the LTB entries corresponding to a segmented load instruction are updated and ready to be consumed, wake up one or more segmented load uops corresponding to the segmented load instruction in the Baler issue queue; and
re-configure, based on a first segmented load uop of the one or more segmented load uops, a write counter at a first LTB entry of the all of the LTB entries such that the write counter at the first LTB entry is configured to track a remaining number or a progress of segmented load uops that are expected to go through data transformation.

18. The system of claim 17, wherein the processor is further configured to execute the instructions to:
send the first segmented load uop from the Baler issue queue to an LTB pipeline of the LTB; and
track the remaining number or the progress of the segmented load uops that are expected to be involved in the data transformation.

19. The system of claim 18, wherein to re-configure the write counter at the first LTB entry includes:
based on the first issued segmented uop, initialize the write counter at the first LTB entry with a pending segmented uop count representing the number of the segmented uops that are expected to be involved in the data transformation.

20. The system of claim 19, wherein to track the remaining number or the progress of the segmented load uops that are expected to be involved in the data transformation further includes to adjust the pending segmented uop count to reflect respective number of the segmented uops that are left to be involved in the data transformation, wherein to adjust includes to subtract the write counter by a numerical value of one for each issued segmented uop that completed the data transformation.
